(19) United States
(12) Patent Application Publication
(10) Pub. No.: US 2024/0176589 A1
(43) Pub. Date: May 30, 2024

(54) Processing Circuit

(71) Applicant: Infineon Technologies AG, Neubiberg (DE)

(72) Inventors: Florian Mendel, München (DE); Franz Klug, Aying (DE)

(21) Appl. No.: 18/519,795

(22) Filed: Nov. 27, 2023

(30) Foreign Application Priority Data
Nov. 29, 2022 (DE) 102022131526.6

(51) Int. Cl. G06F 7/544

(52) U.S. Cl. CPC G06F 7/5443

(57) ABSTRACT

A processing circuit comprises a first multiplier configured to determine three shares of the product of the first operand with a blinding value by multiplying each share of the first operand with each share of the blinding value according to a first split of the blinding value into three first shares. The processing circuit further comprises one or more first adders configured to determine, for each share of the second operand, the sum of the share of the second operand with a respective corresponding second share of the blinding value according to a second split of the blinding value into three second shares, wherein the first and second splits of the blinding value are different. The processing circuit is configured to determine shares of the product of the first operand with the second operand from the results of the first multiplier and the one or more first adders.

### TECHNICAL FIELD

The present disclosure relates to processing circuits.

### BACKGROUND

In the context of security-relevant applications, computer chips, such as those on a smart card or in a control device in a vehicle, typically perform cryptographic operations for encryption, decryption and authentication, etc wherein data is processed, such as cryptographic keys, which are to be protected from access by an attacker. A typical security mechanism is the masking of data to be processed. In particular, for a non-linear operation on one or more numbers, such as multiplying two numbers, the numbers may be randomly split into two (or even more) shares and the operation may be performed using the shares to generate a result which is also represented by two or more shares. Splitting a number into shares may also be seen as masking the number. While this may provide some level of protection, information may still leak if the two numbers which are multiplied are not independent (e.g., even equal). An approach to address this issue is to introduce a random blinding value which is combined with both operands in the calculation of the product of the two operands but even then information may be extracted by an attacker using side-channel attacks.

Accordingly, processing circuits for multiplication of two operands with improved security against side-channel attacks are desirable.

### SUMMARY

According to various embodiments, a processing circuit is provided comprising one or more inputs configured to receive three shares of a first operand and three shares of a second operand and a first multiplier configured to determine three shares of the product of the first operand with a blinding value by multiplying each share of the first operand with each share of the blinding value according to a first split of the blinding value into three shares (i.e. a first set of shares). The processing circuit further comprises one or more first adders configured to determine, for each share of the second operand, the sum of the share of the second operand with a respective corresponding second share of the blinding value according to a second split of the blinding value into three shares (i.e. a second set of shares), wherein the first split of the blinding value is different from the second split of the blinding value, a second adder configured to determine the sum of the sums determined by the one or more first adders, one or more second multipliers configured to determine, for each share of the first operand, the product of the share of the first operand with the sum determined by the second adder, and one or more third adders configured to determine, for each product determined by the one or more second multipliers, a respective share of the product of the first operand with the second operand by summing the product determined by the one or more second multipliers with a respective corresponding share of the product of the first operand with the blinding value.

### BRIEF DESCRIPTION OF THE FIGURES

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a processing circuit for multiplying two operands wherein the two operands are each split into two shares.

FIG. 2 shows a processing circuit for multiplying two operands wherein the two operands are split each into three shares.

FIG. 3 shows a processing circuit where two operands and a blinding value are split each into three shares.

FIG. 4 shows a processing circuit according to an embodiment.

### DETAILED DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

Multiplication of two operands is an operation that is required for many data processing tasks, in particular for cryptographic processing such as signing, encryption and decryption. Data processing devices that handle data (e.g., cryptographic keys) that should be kept secret, like a smart card like for example a debit or credit card but also a personal computer, laptop, tablet, server, IoT (Internet of Things) device, microcontroller, smart card, secure microcontroller, dongle, hardware root of trust, (embedded) secure element (ESE), Trusted Platform Module (TPM), or Hardware Security Module (HSM), etc., may comprise a processing circuit for multiplying two operands which is protected against side-channel attacks. A typical approach for such a protection is the usage of shares, i.e. the splitting of the operands into shares.

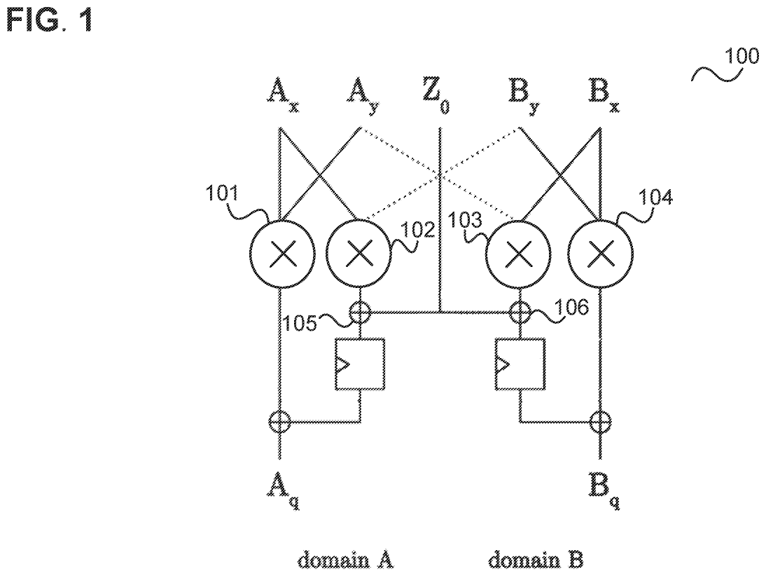

FIG. 1 shows a processing circuit 100 for multiplying two operands X and Y wherein the two operands X and Y are each split into two shares.

For simplicity, it is in the following assumed that the multiplication is carried out in a field with characteristic 2, namely GF(2ⁿ).

X is split into two shares A_{X} and B_{X} such that X=A_{X}+B_{X} and Y is split into two shares A_{Y} and B_{Y} such that Y=A_{Y}+B_{Y}.

Accordingly, the product of X and Y involves four multiplications:

X*Y=A_{X}*A_{Y}+A_{X}*B_{Y}+B_{X}*A_{Y}+B_{X}*B_{Y}

Each of these multiplications is performed by a respective one of four multipliers 101 to 104.

The shares A_{X} and A_{Y} may be seen to be shares of a first domain (domain A) and the shares B_{X} and B_{Y} may be seen to be shares of a second domain (domain B). The result of the multiplication is again represented as a sum of shares for each domain wherein, for increasing security, a random value Z₀ is added (by adders 105, 106) in each domain such that

X*Y=A_{q}+B_{q}=(A_{X}*A_{Y}+A_{X}*B_{Y}+Z₀)+(B_{X}*A_{Y}+B_{X}*B_{Y}+Z₀)

Since it is assumed that the multiplications are carried out in a field with characteristic 2, it holds that Z_{q}+Z_{q}=0 and thus the result is not changed by adding Z₀ in both domains. Accordingly, the multipliers 101 to 104 are also assumed to perform multiplications according to GF(2ⁿ) wherein n is the number of bits of each of X. Y, their shares and Z₀.

The processing circuit 100 provides first order security, the randomness is n bits (number of bits of Z₀). To provide higher order security, more shares may be used.

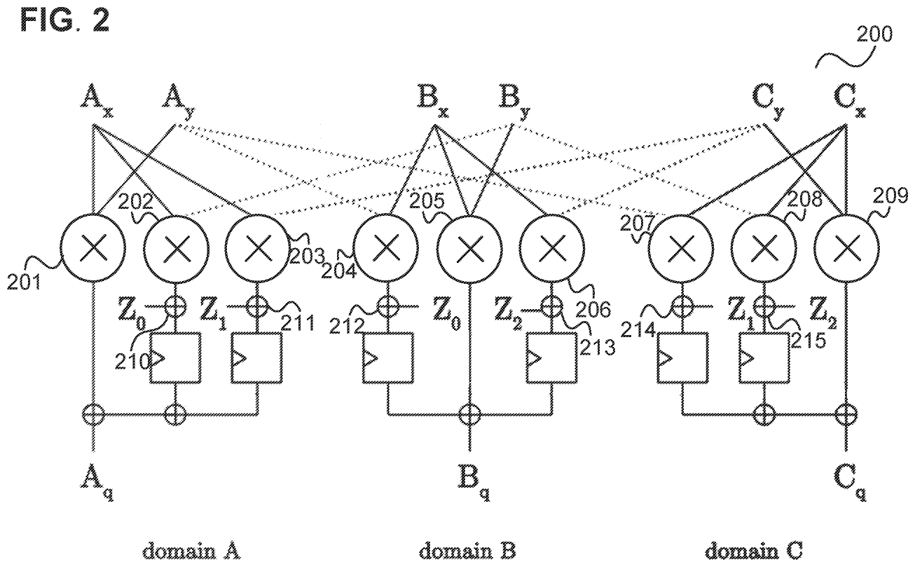

FIG. 2 shows a processing circuit 200 wherein the two operands X and Y are split each into three shares.

Instead of splitting the two operands X and Y each into two shares, each operand is split into three shares:

X=A_{X}+B_{X}+C_{X}

Y=A_{Y}+B_{Y}+C_{Y}

Accordingly, there are three domains A, B, C and the nine products for calculating X*Y (according to the nine possible pairs of one share of X and one share of Y) are performed by nine multipliers 201 to 209.

Further, there are not three random values Z₀, Z₁ and Z₂ which are added (in different combinations) to results of the multipliers 201 to 209 in the domains A, B and C by adders 210 to 215.

The processing circuit 200 provides second order security, the randomness is 3n bits.

However, the multipliers 100, 200 of FIGS. 1 and 2 are only secure if the inputs and sharing of X and Y are independent. If they are dependent, which may in particular be the case if X=Y (which may occur in a cryptographic processing), side channel attacks may allow an attacker to extract information about X and Y.

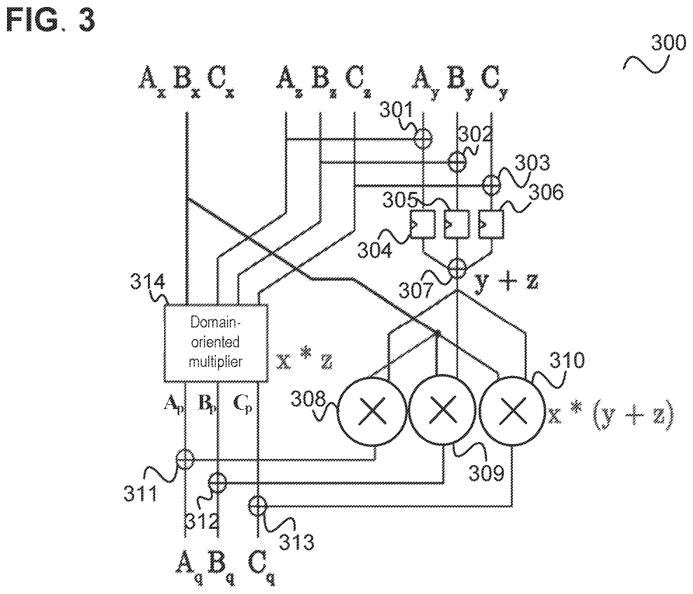

To address this issue, an additional blinding value, which is itself split into shares, may be used, as illustrated by FIG. 3 for the case of three domains.

FIG. 3 shows a processing circuit 300 where two operands X and Y and a blinding value Z are split each into three shares.

So, there are three input operands for the multiplication which are each split into three shares:

X=A_{X}+B_{X}+C_{X}

Y=A_{Y}+B_{Y}+C_{Y}

Z=A_{Z}+B_{Z}+C_{Z}

The shares of X and Z are fed to a first multiplier 314 which may be implemented like the processing circuit 200 of FIG. 2 and processes these shares in the manner described with reference to FIG. 2. In particular, it generates shares Aₚ, Bₚ, Cₚ of X*Z (corresponding to A_{q}, B_{q}, C_{q} output by the processing circuit 200 of FIG. 2; the index p is here used for distinction from the final output shares A_{q}, B_{q}, C_{q} of the processing circuit 300) by multiplying each share of X with each share of Z.

The shares A_{Z} and A_{Y} are fed to a first adder 301 whose result is stored in a first register 304. The shares B_{Z} and B_{Y} are fed to a second adder 302 whose result is stored in a second register 305. The shares C_{Z} and C_{Y} are fed to a third adder 303 whose result is stored in a third register 306.

The values stored by the registers 304, 305, 306 are added by a fourth adder 307 (which thus generates Y+Z as its result) whose result is multiplied with A_{X} by a second multiplier 308, with B_{X} by a third multiplier 309 and to C_{X} by a fourth multiplier 310.

The result of the second multiplier 308 is added to Aₚ by a fourth adder 311, the result of the third multiplier 309 is added to Bₚ by a fifth adder 312, and the result of the fourth multiplier 310 is added to Cₚ by a sixth adder 313.

The result of the fourth adder 311 is A_{q}, the result of the fifth adder 312 is B_{q} and the result of the sixth adder 313 is C_{q}.

Again, it is assumed that operations take place in a field with characteristic 2 such that Z+Z=0. Therefore, A_{q}+B_{q}+C_{q}=X*Y.

The randomness in the processing circuit 300 is 6n bits.

The blinding value Z increases security against side-channel attacks. However, it can be seen that in the first multiplier 314 the product B_{X}*A_{Z} occurs and that in the fourth multiplier, the product (A_{Y}+A_{Z})*C_{X} may occur due to glitches (i.e. different runtimes of the respective signals in hardware) which is equal to (A_{X}+A_{Z})*C_{X} if X=Y and the sharing of X and Y is not independent. If an attacker repeatedly probes both values, the attacker can get statistical information about these two values (i.e. information about a joint probability distribution of these two values) which leaks information.

This lack of security may be avoided by re-masking inputs and use a multiplier as described with reference to FIG. 2 and re-sharing X and Y independently in an additional register state before being used which, however, increases complexity significantly. Another approach is to introduce a register stage in the decode part in the right branch, i.e. after the fourth adder 307, to avoid glitches leading to values like (A_{Y}+A_{Z})*C_{X} from occurring in the fourth multiplier 310. The additional registers stage leads to higher latency, however.

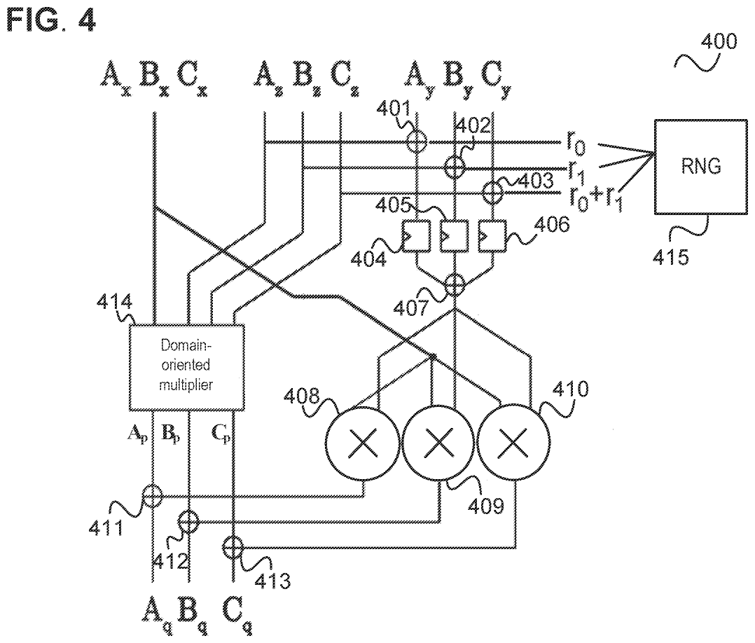

In view of the above, according to various embodiments, to address the lack of security of the processing circuit 300 against side-channel attacks described above, a change of the shares of Z and thus also of Y+Z (also denoted as “re-sharing”) is introduced without the need of introducing an additional register stage as shown in FIG. 4. This results in a second order secure implementation of the multiplier for dependent inputs (resp. shares) with three shares that only needs one register stage.

FIG. 4 shows a processing circuit 400 according to an embodiment.

Similar to the processing circuit 300 described with reference to FIG. 3, the processing circuit 400 comprises adders 401, 402, 403, 411, 412, 413, multipliers 408, 409, 410, 414 and registers 404, 405, 406. The only difference is that the first adder 401 further adds a first random value r₀ to the sum of A_{Z} and A_{Y}, the second adder 402 further adds a second random value r₁ to the sum of B_{Z} and B_{Y} and the third adder 403 further adds a the sum of r₀ and r₁ to the sum of A_{Z} and A_{Y}.

This may also be seen as that with respect to the left branch (i.e. the first multiplier 414) the third (random) operand Z is re-shared for the right branch (i.e. in particular for the first adder 407): this means that instead of A_{Z}, B_{Z} and C_{Z} the right branch uses A_{Z}+r₀, B_{Z}+r₁ and C_{Z}+r₀+r₁. As above, operations in a field with characteristic 2 are assumed such that A_{Z}+r₀+B_{Z}+r₁+C_{Z}+r₀+r₁=A_{Z}+B_{Z}+C_{Z}=Z.

In other words, the left branch and the right branch use different splits of the blinding value Z into shares, i.e. a split of Z into first shares (i.e. a first set of shares) is used by the left branch which is different from a split of Z into second shares (i.e. a second set of shares) used by the right branch.

Accordingly, r₀, r₁ and r₀+r₁ can be seen as re-sharing values for Z (i.e. values for changing the shares of Z) including a respective corresponding re-sharing value for each share A_{Z}, B_{Z}, C_{Z} of the first operand which can be seen to be re-shared to (second) shares A_{Z}+r₀, B_{Z}+r₁ and C_{Z}+r₀+r₁).

Each of r₀ and r₁ is a random n bit value such that the randomness of the processing circuit 400 is 8n (thus requiring more randomness than the processing circuit 300 of FIG. 3, i.e. more output from a random number generator 415 which is part of or connected to the processing circuit 400; this or another random number generator may also provide the random number Z and randomness for the various shares). An additional register stage is not needed.

Since the left branch and the right branch use different splitting of Z, an attacker cannot extract information by combining values occurring in the two branches. Specifically, the problem described above does not occur since instead of (A_{Y}+A_{Z})*C_{X} the value (A_{Y}+A_{Z}+r₀)*C_{X} would occur in the fourth multiplier 310 which does not allow an attacker extracting information by combining it with B_{X}*A_{Z} from the right branch since it includes the random value r₀.

In summary, according to various embodiments, a processing circuit is provided comprising
one or more inputs configured to receive three shares of a first operand (X in the examples above) and three shares of a second operand (Y in the examples above);
A first multiplier (e.g., the first multiplier 414 in the example of FIG. 4) configured to determine three shares (Aₚ, Bₚ, Cₚ in the example above) of the product of the first operand with a blinding value (which may be seen as third operand and which may be a random value, i.e. may be generated by a random number generator, Z in the examples above) by multiplying each share of the first operand with each share of the blinding value according to a first split of the blinding value into three first shares (i.e. a first set of shares, A_{Z}, B_{Z} and C_{Z} in the example above);
One or more first adders (adders 401 to 403 in the example of FIG. 4) configured to determine, for each share of the second operand, the sum of the share of the second operand with a respective corresponding second share of the blinding value according to a second split of the blinding value into three second shares (i.e. a second set of shares, A_{Z}+r₀, B_{Z}+r₁ and C_{Z}+r₀+r₁ in the example above), wherein the first split of the blinding value is different (preferably independent) from the second split of the blinding value;
A second adder (adder 407 in the example of FIG. 4) configured to determine the sum of the sums determined by the one or more first adders;
One or more second multipliers (multipliers 408 to 410 in the example of FIG. 4) configured to determine, for each share of the first operand, the product of the share of the first operand with the sum determined by the second adder;
One or more third adders (adders 411 to 413 in the example of FIG. 4) configured to determine, for each product determined by the one or more second multipliers, a respective share (i.e. a share of the result or “result share”, A_{q}, B_{q}, C_{q} in the example above) of the product of the first operand with the second operand by summing the product determined by the one or more second multipliers with a respective corresponding share of the product of the first operand with the blinding value.

According to various embodiments, in other words, as explained above, two different splits of the blinding value (which may be seen as blinding value) are used in two branches of the processing circuit whose results are combined at the output (by the one or more third adders) to get the final result (i.e. the shares of the product of the first operand with the second operand which the processing circuit may output as processing result).

The “respective corresponding” share of an operand to a share of another operand can be seen to be the share at the same position in an ordering of the shares of the operand as the share in an ordering of the shares of the other operand. So, as in the examples above, where shares are ordered (and denoted) according to A, B, C, the share A_{X} of operand X corresponds to A_{Z} of operand Z and the share B_{X} of operand X corresponds to B_{Z} of operand Z so on.

Various Examples are described in the following:
Example 1 is a processing circuit as summarized in the bullet points above.
Example 2 is the processing circuit of example 1, comprising, for each share of the second operand, a respective sequential element, wherein the one or more adders are configured to store the sum of the share of the second operand with the respective corresponding second share of the blinding value into the sequential element.
Example 3 is the processing circuit of example 2, wherein the second adder comprises, for each share of the second operand, an input connected to the sequential element for the share of the second operand configured to receive the sum determined by the one or more first adders for the share of the second operand from the sequential element.
Example 4 is the processing circuit of any one of examples 1 to 3, wherein the one or more first adders comprise a respective first adder for each share of the second operand configured to add the share of the second operand to the respective corresponding second share of the blinding value.
Example 5 is the processing circuit of any one of examples 1 to 4, wherein the one or more second multipliers comprise a respective second multiplier for each share of the first operand configured to multiply the share of the first operand with the sum determined by the second adder.
Example 6 is the processing circuit of any one of examples 1 to 5, wherein the one or more third adders comprise a respective third adder for each product determined by the one or more second multipliers configured to determine the respective share of the product of the first operand with the second operand.
Example 7 is the processing circuit of any one of examples 1 to 6, wherein the first multiplier and the one or more second multipliers are configured to multiply in accordance with a field of characteristic two and the second adder and the one or more third adders are configured to add in accordance with the field of characteristic two.
Example 8 is the processing circuit of example 7, wherein the field is GF(2ⁿ) wherein n is the number of bits of the first operand and the second operand.
Example 9 is the processing circuit of any one of examples 1 to 8, wherein the one or more inputs comprise an input configured to receive the first shares of the blinding value and the one or more adders are configured to determine, for each share of the second operand, the sum of the share of the second operand with the respective corresponding second share of the blinding value by adding the share of the second operand, the respective corresponding first share of the blinding value and a respective corresponding re-sharing value.
Example 10 is the processing circuit of example 9, comprising one or more random number generators configured to provide a first and a second of the re-sharing values, wherein the third re-sharing value is the sum of the first re-sharing value and the second re-sharing value.
Example 11 is the processing circuit of any one of examples 1 to 10, wherein the first multiplier is configured to determine the shares of the product of the first operand with the blinding value by combining results of the multiplying of, for each share of the first operand, the share of the first operand with the respective corresponding first share of the blinding value.

It should be noted that a sequential element be a set or an array of one or more flip-flops (e.g., a register).

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A processing circuit comprising
one or more inputs configured to receive three shares of a first operand and three shares of a second operand;
a first multiplier configured to determine three shares of the product of the first operand with a blinding value by multiplying each share of the first operand with each share of the blinding value according to a first split of the blinding value into three first shares;
one or more first adders configured to determine, for each share of the second operand, the sum of the share of the second operand with a respective corresponding second share of the blinding value according to a second split of the blinding value into three second shares, wherein the first split of the blinding value is different from the second split of the blinding value;
a second adder configured to determine the sum of the sums determined by the one or more first adders;
one or more second multipliers configured to determine, for each share of the first operand, the product of the share of the first operand with the sum determined by the second adder;
one or more third adders configured to determine, for each product determined by the one or more second multipliers, a respective share of the product of the first operand with the second operand by summing the product determined by the one or more second multipliers with a respective corresponding share of the product of the first operand with the blinding value.

2. The processing circuit of claim 1, comprising, for each share of the second operand, a respective sequential element, wherein the one or more adders are configured to store the sum of the share of the second operand with the respective corresponding second share of the blinding value into the sequential element.

3. The processing circuit of claim 2, wherein the second adder comprises, for each share of the second operand, an input connected to the sequential element for the share of the second operand configured to receive the sum determined by the one or more first adders for the share of the second operand from the sequential element.

4. The processing circuit of claim 1, wherein the one or more first adders comprise a respective first adder for each share of the second operand configured to add the share of the second operand to the respective corresponding second share of the blinding value.

5. The processing circuit of claim 1, wherein the one or more second multipliers comprise a respective second multiplier for each share of the first operand configured to multiply the share of the first operand with the sum determined by the second adder.

6. The processing circuit of claim 1, wherein the one or more third adders comprise a respective third adder for each product determined by the one or more second multipliers configured to determine the respective share of the product of the first operand with the second operand.

7. The processing circuit of claim 1, wherein the first multiplier and the one or more second multipliers are configured to multiply in accordance with a field of characteristic two and the second adder and the one or more third adders are configured to add in accordance with the field of characteristic two.

8. The processing circuit of claim 7, wherein the field is GF(2ⁿ) wherein n is the number of bits of the first operand and the second operand.

9. The processing circuit of claim 1, wherein the one or more inputs comprise an input configured to receive the first shares of the blinding value and the one or more adders are configured to determine, for each share of the second operand, the sum of the share of the second operand with the respective corresponding second share of the blinding value by adding the share of the second operand, the respective corresponding first share of the blinding value and a respective corresponding re-sharing value.

10. The processing circuit of claim 9, comprising one or more random number generators configured to provide a first and a second of the re-sharing values, wherein the third re-sharing value is the sum of the first re-sharing value and the second re-sharing value.

11. The processing circuit of claim 1, wherein the first multiplier is configured to determine the shares of the product of the first operand with the blinding value by combining results of the multiplying of, for each share of the first operand, the share of the first operand with the respective corresponding first share of the blinding value.
